(19) United States
(12) Patent Application Publication
(10) Pub. No.: US 2026/0183963 A1
(43) Pub. Date: Jul. 2, 2026

(54) METHODS AND APPARATUS FOR CONTROLLING A ROBOT BASED ON VIDEO

(71) Applicant: Boston Dynamics, Inc., Waltham, MA (US)

(72) Inventors: Kevin Bergamin, Cambridge, MA (US); Michael Lutter, Cambridge, MA (US); Johanna Hansen, Lincoln, MA (US); C. Dario Bellicoso, Zurich (CH); Scott Kuindersma, Bedford, MA (US)

(21) Appl. No.: 19/002,862

(22) Filed: Dec. 27, 2024

(51) Int. Cl. B25J 9/16

(52) U.S. Cl. CPC B25J 9/1697; B25J 9/1664

(57) ABSTRACT

Methods and apparatus for controlling a robot are provided. The method includes receiving a kinematic trajectory for a robot, wherein the kinematic trajectory is based, at least in part, on one or more features extracted from video data, the video data including one or more bipeds performing a task by interacting with one or more objects, the one or more features including a first feature corresponding to a biped and second feature corresponding to an object, and determining a control policy for the robot based, at least in part, on the kinematic trajectory.

### FIELD OF THE INVENTION

This disclosure relates generally to controls for robotics and more specifically to controlling robots using video.

### BACKGROUND

A robot is generally defined as a reprogrammable and multifunctional manipulator designed to move material, parts, tools, and/or specialized devices (e.g., via variable programmed motions) for performing tasks. Robots may include manipulators that are physically anchored (e.g., industrial robotic arms), mobile devices that move throughout an environment (e.g., using legs, wheels, or traction-based mechanisms), or some combination of one or more manipulators and one or more mobile devices. Robots are currently used in a variety of industries, including, for example, manufacturing, warehouse logistics, transportation, hazardous environments, exploration, and healthcare.

### SUMMARY

A variety of settings today demand high levels of automation, e.g., factories, transportation facilities, material handling facilities and warehouses, among others. At least some of the automation in such environments may be provided by robots that can perform tasks, such as moving objects (e.g., automobile parts) from a first location to a second location (e.g., a so-called “pick and place” operation), lifting heavy objects, etc. While certain types of tasks in such environments may be performed by robots mounted at a fixed location or mobile wheeled robots, other tasks may be more well-suited for robots with legs. Humanoid robots may be legged robots that include components (e.g., feet, arms, torso, head, hands) modeled after the human form with members connected by joints that enable the members to rotate with one or more degrees of freedom about the joint.

A humanoid robot when deployed in an environment such as a warehouse may be capable of performing a wide variety of tasks that involve manipulation of objects in the environment. For instance, a humanoid robot may grasp an object at one location in the environment, walk with the object to a second location in the environment, and place the object at the second location. Successful completion of such tasks may require the robot to learn control methods (e.g., control polices) that specify how a controller of the robot should actuate its joints to perform coordinated movements. Such control methods may be learned by a human operator programming or otherwise controlling the robot to move in specified ways that achieve a desired coordinated motion. The inventors have recognized and appreciated that such control methods may alternatively be learned based on video data (e.g., showing a human interacting with the object(s) to perform particular tasks). Some embodiments of the present disclosure relate to extracting relevant information from video data, which may be used to determine a kinematic trajectory for a robot for which a control method (e.g., a control policy) for the robot may be generated to enable the robot to perform a task depicted in the video data.

In some embodiments the invention features a method for controlling a robot. The method includes receiving a kinematic trajectory for a robot, wherein the kinematic trajectory is based, at least in part, on one or more features extracted from video data, the video data including one or more bipeds performing a task by interacting with one or more objects, the one or more features including a first feature corresponding to a biped and second feature corresponding to an object, and determining a control policy for the robot based, at least in part, on the kinematic trajectory.

In one aspect, the method further includes receiving the video data, and extracting, with at least one processor, the one or more features from the video data, and receiving the kinematic trajectory for the robot comprises determining the kinematic trajectory based, at least in part, on the one or more features. In another aspect, the video data includes first video data showing a first view of the one or more bipeds performing the task and second video data showing a second view of the one or more bipeds performing the task, extracting the one or more features comprises extracting the one or more features from the first video data and the second video data, and determining the kinematic trajectory is based, at least in part, on the one or more features extracted from the first video data and the one or more features extracted from the second video data. In another aspect, the one or more features include a set of keypoints located on the one or more bipeds and the one or more objects, extracting the one or more features comprises identifying the set of keypoints in the first video data and the second video data, and determining the kinematic trajectory comprises combining information from the set of keypoints identified in the first video data and information from the set of keypoints identified in the second video data to determine the kinematic trajectory as a three-dimensional kinematic trajectory. In another aspect, combining information from the set of keypoints identified in the first video data and information from the set of keypoints identified in the second video data includes determining depth information for one or more keypoints in the set of keypoints, and determining the kinematic trajectory based, at least in part, on the depth information. In another aspect, the set of keypoints is a first set of keypoints, and the method further includes defining a mapping between the first set of keypoints and a second set of keypoints defined on a morphology of the robot, and determining the kinematic trajectory is further based, at least in part, on the mapping. In another aspect, determining the kinematic trajectory based, at least in part, on the mapping comprises performing retargeting of the set of keypoints onto the morphology of the robot using the mapping. In another aspect, the method further includes determining, for each keypoint in the set of keypoints, a keypoint trajectory based on the first video data and the second video data, and determining the kinematic trajectory is further based on the keypoint trajectories.

In another aspect, the kinematic trajectory is further based, at least in part, on information about the robot. In another aspect, the kinematic trajectory describes a motion of the robot in three dimensions. In another aspect, determining a control policy for the robot based, at least in part, on the kinematic trajectory comprises using adversarial motion priors to determine the control policy. In another aspect, determining a control policy for the robot comprises determining the control policy based, at least in part, on contact geometry between the robot and the object. In another aspect, the control policy comprises a control policy for controlling the robot to manipulate an object. In another aspect, the method further includes controlling the robot to execute the control policy to perform the task. In another aspect, the one or more bipeds include one or more humans.

In some embodiments, the invention features a controller for a robot. The controller is configured to receive a kinematic trajectory for the robot, wherein the kinematic trajectory is based, at least in part, on one or more features extracted from video data, the video data including one or more bipeds performing a task by interacting with one or more objects, the one or more features including a first feature corresponding to a human and second feature corresponding to an object, determine a control policy for the robot based, at least in part, on the kinematic trajectory, and control the robot to execute the control policy to perform the task.

In one aspect, the controller is further configured to receive the video data, extract the one or more features from the video data, and determine the kinematic trajectory based, at least in part, on the one or more features. In another aspect, the video data includes first video data showing a first view of the one or more bipeds performing the task and second video data showing a second view of the one or more bipeds performing the task, the controller is configured to extract the one or more features by extracting the one or more features from the first video data and the second video data, and the controller is configured to determine the kinematic trajectory based, at least in part, on the one or more features extracted from the first video data and the one or more features extracted from the second video data. In another aspect, the one or more features include a set of keypoints located on the one or more bipeds and the one or more objects, the controller is configured to extract the one or more features by identifying the set of keypoints in the first video data and the second video data, and the controller is configured to determine the kinematic trajectory by combining information from the set of keypoints identified in the first video data and information from the set of keypoints identified in the second video data to determine the kinematic trajectory as a three-dimensional kinematic trajectory. In another aspect, combining information from the set of keypoints identified in the first video data and information from the set of keypoints identified in the second video data includes determining depth information for one or more keypoints in the set of keypoints, and determining the kinematic trajectory based, at least in part, on the depth information. In another aspect, the set of keypoints is a first set of keypoints, and the controller is further configured to define a mapping between the first set of keypoints and a second set of keypoints defined on a morphology of the robot, and determining the kinematic trajectory is further based, at least in part, on the mapping. In another aspect, determining the kinematic trajectory based, at least in part, on the mapping comprises performing retargeting of the set of keypoints onto the morphology of the robot using the mapping. In another aspect, the controller is further configured to determine, for each keypoint in the set of keypoints, a keypoint trajectory based on the first video data and the second video data, and determining the kinematic trajectory is further based on the keypoint trajectories.

In another aspect, the kinematic trajectory is further based, at least in part, on information about the robot. In another aspect, the kinematic trajectory describes a motion of the robot in three dimensions. In another aspect, the controller is further configured to determine the control policy for the robot by using adversarial motion priors. In another aspect, the controller is further configured to determine the control policy based, at least in part, on contact geometry between the robot and the object. In another aspect, the control policy comprises a control policy for controlling the robot to manipulate an object. In another aspect, the one or more bipeds include one or more humans.

In some embodiments, the invention features a robot. The robot includes a set of members, a set of joints coupling the set of members, a set of actuators configured to move the set of members at the set of joints, and a controller. The controller is configured to execute a control policy to control the set of actuators to enable the robot to perform a task, wherein the control policy is based, at least in part, on a kinematic trajectory for the robot, and wherein the kinematic trajectory for the robot is based, at least in part, on one or more features extracted from video data, the video data including one or more bipeds performing the task by interacting with one or more objects, the one or more features including a first feature corresponding to a biped and second feature corresponding to an object.

In some embodiments, the invention features a controller for a robot. The controller is configured to execute a control policy to control the robot to perform a task, wherein the control policy is based, at least in part, on a kinematic trajectory for the robot, and the kinematic trajectory for the robot is based, at least in part, on one or more features extracted from video data, the video data including one or more humans performing the task by interacting with one or more objects, the one or more features including a first feature corresponding to a human and second feature corresponding to an object.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIG. 1 shows an example configuration of a robotic device, according to an illustrative embodiment of the invention.

FIG. 2A shows an example of a humanoid robot, according to an illustrative embodiment of the invention.

FIG. 2B shows an example of various actuators of a humanoid robot, according to an illustrative embodiment of the invention.

FIG. 3 is a flowchart of a process for learning a control policy for a robot based on video data, according to an illustrative embodiment of the invention.

FIG. 4A schematically illustrates a process for identifying a set of keypoints associated with a human in an image, according to an illustrative embodiment of the invention.

FIG. 4B schematically illustrates a process for combining a set of keypoints identified in multi-view video data, according to an illustrative embodiment of the invention.

FIG. 4C schematically illustrates a process for matching keypoints associated with a human to keypoints on a robot morphology, according to an illustrative embodiment of the invention.

FIG. 4D illustrates an example processing architecture for generating a control policy for a robot using adversarial motion priors, according to an illustrative embodiment of the invention.

FIG. 5 depicts a process for learning control policies for a robot based on video data of a human demonstrating an interaction with an object, according to an illustrative embodiment of the invention.

FIG. 6 is a flowchart of a process for generating a control policy for a robot based on multi-view video data, according to an illustrative embodiment of the invention.

### DETAILED DESCRIPTION

Humanoid robots may be programmed or otherwise configured to manipulate physical objects in their environment by moving their coupled members and joints in prescribed ways that achieve coordinated movement of the robot. Configuring the robot to perform such behaviors typically requires the input of skilled human operators or teleoperation techniques, which may limit widespread adoption of such robots. The inventors have recognized and appreciated that data associated with demonstrations (e.g., human demonstrations) of movements such as reaching, walking, jumping, object manipulation etc. may provide a suitable information source from which a humanoid robot may learn a one or more control methods (e.g., control policies) to perform similar movements. Some conventional techniques for acquiring such data includes the use of motion capture systems, in which human actors wear specialized suits with sensors that can be tracked in three dimensions. The limited availability and/or fixed infrastructure associated with motion capture systems may render their use impractical for sourcing human demonstration data for training robots to perform new object manipulation tasks.

The inventors have recognized and appreciated that video data depicting humans (or other bipeds, such as other humanoid robots) manipulating objects may alternatively be used as source data to determine a control method (e.g., train a control policy) for a humanoid robot. For example, video data depicting different views of a human interacting with an object (e.g., a human lifting and carrying a box) may be used to generate three-dimensional reference kinematic trajectories of the human and/or object that may be used to generate control methods that enable the humanoid robot to perform the same object manipulation depicted in the video data. Such video data may provide an abundant and context-rich information source to program object manipulation strategies for a humanoid robot. Some embodiments of the present disclosure relate to techniques for determining a control method (e.g., a control policy) for a robot based, at least in part, on an analysis of video data in which one or more humans are demonstrating performance of a task.

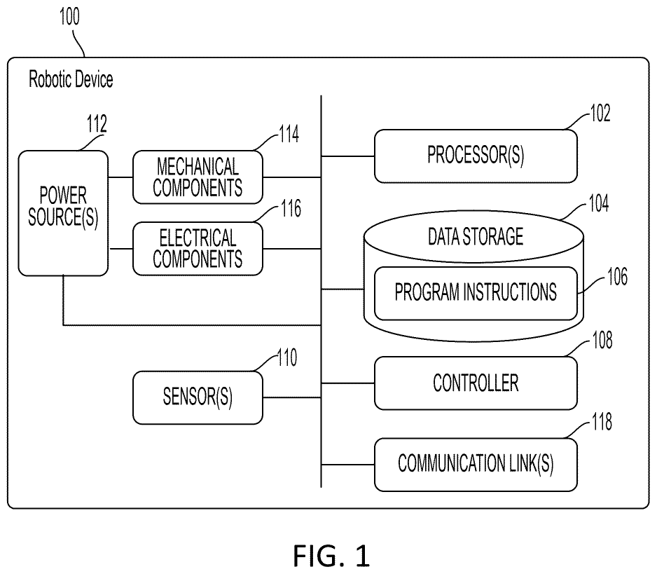

Referring now to the figures, FIG. 1 illustrates an example configuration of a robotic device (or “robot”) 100, according to an illustrative embodiment of the invention. The robotic device 100 represents an example robotic device configured to perform the operations described herein. Additionally, the robotic device 100 may be configured to operate autonomously, semi-autonomously, and/or using directions provided by user(s), and may exist in various forms, such as a humanoid robot, biped, quadruped, or other mobile robot, among other examples. Furthermore, the robotic device 100 may also be referred to as a robotic system, mobile robot, or robot, among other designations.

As shown in FIG. 1, the robotic device 100 includes processor(s) 102, data storage 104, program instructions 106, controller 108, sensor(s) 110, power source(s) 112, mechanical components 114, and electrical components 116. The robotic device 100 is shown for illustration purposes and may include more or fewer components without departing from the scope of the disclosure herein. The various components of robotic device 100 may be connected in any manner, including via electronic communication means, e.g., wired or wireless connections. Further, in some examples, components of the robotic device 100 may be positioned on multiple distinct physical entities rather on a single physical entity. Other example illustrations of robotic device 100 may exist as well.

Processor(s) 102 may operate as one or more general-purpose processor or special purpose processors (e.g., digital signal processors, application specific integrated circuits, etc.). The processor(s) 102 can be configured to execute computer-readable program instructions 106 that are stored in the data storage 104 and are executable to provide the operations of the robotic device 100 described herein. For instance, the program instructions 106 may be executable to provide operations of controller 108, where the controller 108 may be configured to cause activation and/or deactivation of the mechanical components 114 and the electrical components 116. The processor(s) 102 may operate and enable the robotic device 100 to perform various functions, including the functions described herein.

The data storage 104 may exist as various types of storage media, such as a memory. For example, the data storage 104 may include or take the form of one or more computer-readable storage media that can be read or accessed by processor(s) 102. The one or more computer-readable storage media can include volatile and/or non-volatile storage components, such as optical, magnetic, organic or other memory or disc storage, which can be integrated in whole or in part with processor(s) 102. In some implementations, the data storage 104 can be implemented using a single physical device (e.g., one optical, magnetic, organic or other memory or disc storage unit), while in other implementations, the data storage 104 can be implemented using two or more physical devices, which may communicate electronically (e.g., via wired or wireless communication). Further, in addition to the computer-readable program instructions 106, the data storage 104 may include additional data such as diagnostic data, among other possibilities.

The robotic device 100 may include at least one controller 108, which may interface with the robotic device 100. The controller 108 may serve as a link between portions of the robotic device 100, such as a link between mechanical components 114 and/or electrical components 116. In some instances, the controller 108 may serve as an interface between the robotic device 100 and another computing device. Furthermore, the controller 108 may serve as an interface between the robotic device 100 and a user(s). The controller 108 may include various components for communicating with the robotic device 100, including one or more joysticks or buttons, among other features. The controller 108 may perform other operations for the robotic device 100 as well. Other examples of controllers may exist as well.

Additionally, the robotic device 100 includes one or more sensor(s) 110 such as force sensors, proximity sensors, motion sensors, load sensors, position sensors, touch sensors, depth sensors, ultrasonic range sensors, and/or infrared sensors, among other possibilities. The sensor(s) 110 may provide sensor data to the processor(s) 102 to allow for appropriate interaction of the robotic device 100 with the environment as well as monitoring of operation of the systems of the robotic device 100. The sensor data may be used in evaluation of various factors for activation and deactivation of mechanical components 114 and electrical components 116 by controller 108 and/or a computing system of the robotic device 100.

The sensor(s) 110 may provide information indicative of the environment of the robotic device for the controller 108 and/or computing system to use to determine operations for the robotic device 100. For example, the sensor(s) 110 may capture data corresponding to the terrain of the environment or location of nearby objects, which may assist with environment recognition and navigation, etc. In an example configuration, the robotic device 100 may include a sensor system that may include a camera, RADAR, LIDAR, time-of-flight camera, global positioning system (GPS) transceiver, and/or other sensors for capturing information of the environment of the robotic device 100. The sensor(s) 110 may monitor the environment in real-time and detect obstacles, elements of the terrain, weather conditions, temperature, and/or other parameters of the environment for the robotic device 100.

Further, the robotic device 100 may include other sensor(s) 110 configured to receive information indicative of the state of the robotic device 100, including sensor(s) 110 that may monitor the state of the various components of the robotic device 100. The sensor(s) 110 may measure activity of systems of the robotic device 100 and receive information based on the operation of the various features of the robotic device 100, such the operation of extendable legs, arms, or other mechanical and/or electrical features of the robotic device 100. The sensor data provided by the sensors may enable the computing system of the robotic device 100 to determine errors in operation as well as monitor overall functioning of components of the robotic device 100.

For example, the computing system may use sensor data to determine the stability of the robotic device 100 during operations as well as measurements related to power levels, communication activities, components that require repair, among other information. As an example configuration, the robotic device 100 may include gyroscope(s), accelerometer(s), and/or other possible sensors to provide sensor data relating to the state of operation of the robotic device. Further, sensor(s) 110 may also monitor the current state of a function, such as a gait, that the robotic device 100 may currently be operating. Additionally, the sensor(s) 110 may measure a distance between a given robotic leg of a robotic device and a center of mass of the robotic device. Other example uses for the sensor(s) 110 may exist as well.

Additionally, the robotic device 100 may also include one or more power source(s) 112 configured to supply power to various components of the robotic device 100. Among possible power systems, the robotic device 100 may include a hydraulic system, electrical system, batteries, and/or other types of power systems. As an example illustration, the robotic device 100 may include one or more batteries configured to provide power to components via a wired and/or wireless connection. Within examples, components of the mechanical components 114 and electrical components 116 may each connect to a different power source or may be powered by the same power source. Components of the robotic device 100 may connect to multiple power sources as well.

Within example configurations, any type of power source may be used to power the robotic device 100, such as a gasoline and/or electric engine. Further, the power source(s) 112 may charge using various types of charging, such as wired connections to an outside power source, wireless charging, combustion, or other examples. Other configurations may also be possible. Additionally, the robotic device 100 may include a hydraulic system configured to provide power to the mechanical components 114 using fluid power. Components of the robotic device 100 may operate based on hydraulic fluid being transmitted throughout the hydraulic system to various hydraulic motors and hydraulic cylinders, for example. The hydraulic system of the robotic device 100 may transfer a large amount of power through small tubes, flexible hoses, or other links between components of the robotic device 100. Other power sources may be included within the robotic device 100.

Mechanical components 114 can represent hardware of the robotic device 100 that may enable the robotic device 100 to operate and perform physical functions. As a few examples, the robotic device 100 may include actuator(s), extendable leg(s) (“legs”), arm(s), wheel(s), one or multiple structured bodies for housing the computing system or other components, and/or other mechanical components. The mechanical components 114 may depend on the design of the robotic device 100 and may also be based on the functions and/or tasks the robotic device 100 may be configured to perform. As such, depending on the operation and functions of the robotic device 100, different mechanical components 114 may be available for the robotic device 100 to utilize. In some examples, the robotic device 100 may be configured to add and/or remove mechanical components 114, which may involve assistance from a user and/or other robotic device. For example, the robotic device 100 may be initially configured with four legs, but may be altered by a user or the robotic device 100 to remove two of the four legs to operate as a biped. Other examples of mechanical components 114 may be included.

The electrical components 116 may include various components capable of processing, transferring, providing electrical charge or electric signals, for example. Among possible examples, the electrical components 116 may include electrical wires, circuitry, and/or wireless communication transmitters and receivers to enable operations of the robotic device 100. The electrical components 116 may interwork with the mechanical components 114 to enable the robotic device 100 to perform various operations. The electrical components 116 may be configured to provide power from the power source(s) 112 to the various mechanical components 114, for example. Further, the robotic device 100 may include electric motors. Other examples of electrical components 116 may exist as well.

In some implementations, the robotic device 100 may also include communication link(s) 118 configured to send and/or receive information. The communication link(s) 118 may transmit data indicating the state of the various components of the robotic device 100. For example, information read in by sensor(s) 110 may be transmitted via the communication link(s) 118 to a separate device. Other diagnostic information indicating the integrity or health of the power source(s) 112, mechanical components 114, electrical components 116, processor(s) 102, data storage 104, and/or controller 108 may be transmitted via the communication link(s) 118 to an external communication device.

In some implementations, the robotic device 100 may receive information at the communication link(s) 118 that is processed by the processor(s) 102. The received information may indicate data that is accessible by the processor(s) 102 during execution of the program instructions 106, for example. Further, the received information may change aspects of the controller 108 that may affect the behavior of the mechanical components 114 or the electrical components 116. In some cases, the received information indicates a query requesting a particular piece of information (e.g., the operational state of one or more of the components of the robotic device 100), and the processor(s) 102 may subsequently transmit that particular piece of information back out the communication link(s) 118.

In some cases, the communication link(s) 118 include a wired connection. The robotic device 100 may include one or more ports to interface the communication link(s) 118 to an external device. The communication link(s) 118 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

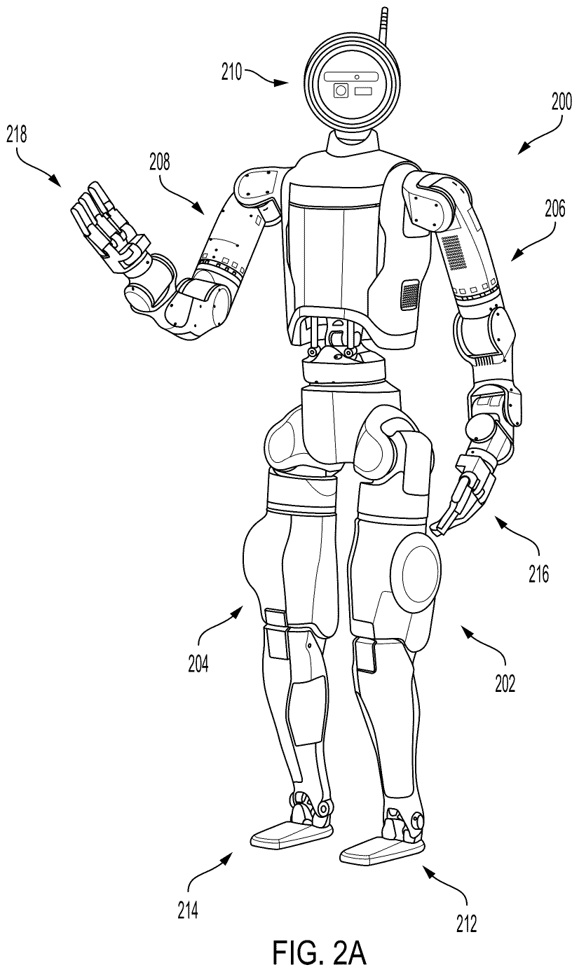

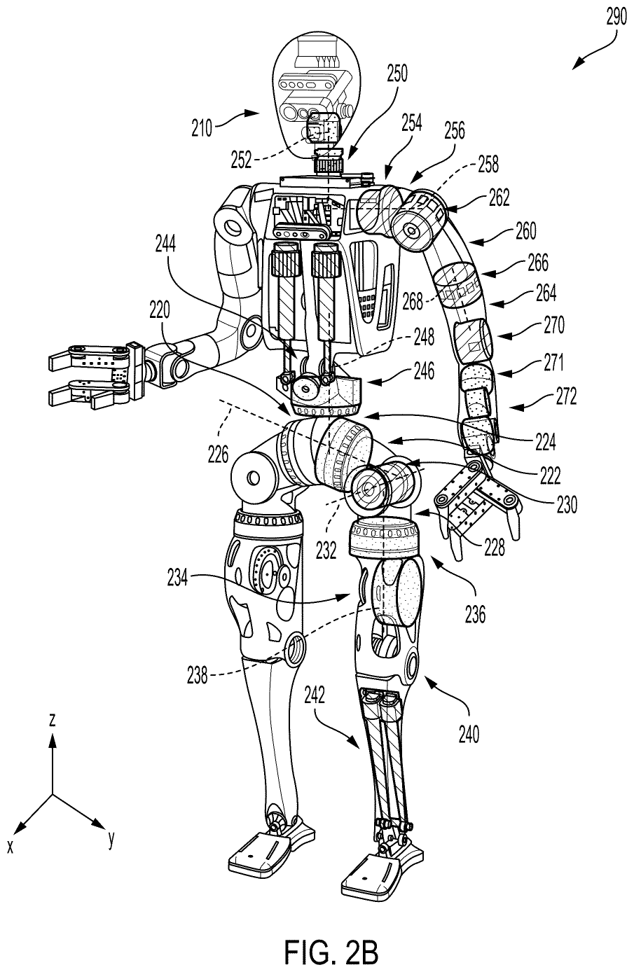

FIG. 2A illustrates an example of a humanoid robot, according to an illustrative embodiment of the invention. The robot 200 may correspond to the robotic device 100 shown in FIG. 1. The robot 200 serves as a possible implementation of a robotic device that may be configured to include the systems and/or carry out the methods described herein. Other example implementations of robotic devices may exist.

The robot 200 may include a number of articulated appendages, such as robotic legs 202, 204 and/or robotic arms 206, 208. The robot 200 may also include a robotic head 210, which may contain one or more vision sensors (e.g., cameras, infrared sensors, object sensors, range sensors, etc.). Each articulated appendage may include a number of (e.g., one, two, three or more) members connected by joints that allow the articulated appendage to move through certain degrees of freedom. For example, each robotic leg 202, 204 may include a respective foot 212, 214, which may contact a surface (e.g., a ground surface). The legs 202, 204 may enable the robot 200 to travel at various speeds according to various gaits. In addition, each robotic arm 206, 208 may facilitate object manipulation, load carrying, and/or balancing of the robot 200. Each arm 206, 208 may also include one or more members connected by joints and may be configured to operate with various degrees of freedom. Each arm 206, 208 may also include a respective end effector (e.g., gripper, hand, etc.) 216, 218. The robot 200 may use end effectors 216, 218 for interacting with (e.g., gripping, turning, pulling, and/or pushing) objects. Each end effector 216, 218 may include various types of appendages or attachments, such as fingers, attached tools or grasping mechanisms. In some embodiments, one or more sensors (e.g., cameras, infrared sensors, object sensors, range sensors, etc.) may be arranged on an arbitrary member or link of the robot.

Robot 200 may also include sensors to measure the angles of the joints of its articulated appendages. In addition, the articulated appendages may include a number of actuators that can be controlled to extend and retract members of the articulated appendages. Examples of actuators that may be included in robot 200 are described in more detail in FIG. 2B. In some cases, the angle of a joint may be determined based on the extent of protrusion or retraction of a given actuator. In some instances, the joint angles may be inferred from position data of inertial measurement units (IMUs) mounted on the members of an articulated appendage. In some implementations, the joint angles may be measured using rotary position sensors, such as rotary encoders. In other implementations, the joint angles may be measured using optical reflection techniques. Other joint angle measurement techniques may also be used.

In some embodiments, robot 200 may include a set of continuous rotation joints, where each continuous rotation joint permits continuous (e.g., 360 degree and/or limitless) rotation about a corresponding axis. Rather than requiring such joints to “unwind” by, for example, always determining a target joint angle relative to a nominal (e.g., 0 degree) orientation, a control system of the robot 200 may be configured to determine that the target joint angle be set at any multiple of 360 degrees (e.g., 0 degrees, 360 degrees, 720 degrees) to permit efficient movement of an attached member about the joint to achieve the target joint angle. For instance, if a target joint angle of a continuous rotation joint is 15 degrees and the current joint angle is 350 degrees, rather that rotating an attached member-335 degrees about the joint, the attached member can instead be rotated +25 degrees (to 375 degrees), which is equivalent to a joint angle of 15 degrees for a continuous rotation joint.

In some embodiments, robot 200 may include a body (e.g., a torso and a base such as a pelvis base) and one or more kinematic chains of robot members (e.g., arms, legs) coupled to the body. Each of the plurality of kinematic chains of robot members may include at least two joints (e.g., a first joint coupling the kinematic chain to the body and a second joint coupling at least two members of the kinematic chain). At least one of the at least two joints in a kinematic chain may be a continuous rotation joint that enables continuous rotation of at least one of the members (and possibly all members if the joint that couples the kinematic member to the body is a continuous rotation joint) of the kinematic chain about the joint.

Robot 200 may be configured to send sensor data from the articulated appendages to a device coupled to robot 200 such as a processing system, a computing system, or a control system. Robot 200 may include a memory, either included in a device on robot 200 or as a standalone component, on which sensor data is stored. In some implementations, the sensor data is retained in the memory for a certain amount of time. In some cases, the stored sensor data may be processed or otherwise transformed for use by a control system on robot 200. In some cases, robot 200 may also transmit the sensor data over a wired or wireless connection (or other electronic communication means) to an external device.

FIG. 2B illustrates an example of a humanoid robot 290, according to an illustrative embodiment of the invention. Humanoid robot 290 may include components (e.g., arms, legs, feet, head) similar to robot 200 of FIG. 2A, which may not be relabeled in FIG. 2B to reduce clutter. Overlaid on the depiction of humanoid robot 290 are a set of actuators that may be used to move an attached member at corresponding joints of the humanoid robot 290 to enable movement of the robot. As described in more detail below, humanoid robot 290 may include different types of actuators and joints that enable different members of the robot to move with varying degrees of freedom, permitting flexibility of movement when desired while restricting movement as appropriate to, for example, avoid or reduce the risk of collisions between robot components.

Humanoid robot 290 includes a base member (e.g., a pelvis base, as shown in FIG. 2B) 220. The pelvis base 220 is rotatably connected to a first hip member 222. An electric actuator 224 may be disposed between the pelvis base 220 and the first hip member 222 (e.g., in, between, connected to, and/or as part of one or both components). In some embodiments, a first portion of the electric actuator 224 may be fixed to the pelvis base 220, and a second portion of the electric actuator 224 may be fixed to the first hip member 222. The electric actuator 224 may be configured to rotate the pelvis base 220 relative to the first hip member 222 about an axis (e.g., a first hip-y axis) 226. The first hip member 222 is also connected to a first intermediate leg member 228. An electric actuator 230 may be disposed between the first hip member 222 and the first intermediate leg member 228 (e.g., in, between, connected to, and/or as part of one or both components). In some embodiments, a first portion of the electric actuator 230 may be fixed to the first hip member 222, and a second portion of the electric actuator 230 may be fixed to the first intermediate leg member 228. The electric actuator 230 may be configured to rotate the first hip member 222 relative to the first intermediate leg member 228 about an axis (e.g., a first hip-x axis) 232. The first intermediate leg member 228 is also connected to a first leg member 234. An electric actuator 236 may be disposed between the first intermediate member 228 and the first leg member 234 (e.g., in, between, connected to, and/or as part of one or both components). In some embodiments, a first portion of the electric actuator 236 may be fixed to the first intermediate member 228, and a second portion of the electric actuator 236 may be fixed to the first leg member 234. The electric actuator 236 may be configured to rotate the first intermediate leg member 228 relative to the first leg member 234 about an axis (e.g., a first hip-z axis) 238. In some embodiments, a second hip member, second intermediate leg member, and second leg member are connected in similar fashion to the first hip member, first intermediate leg member, and first leg member, using similar actuators rotating along similar additional axes and/or providing similar independently actuatable degrees of freedom.

The axis 226 may be referred to as a first hip-y axis, which denotes a flexion/extension axis of the robot 200. The axis 232 may be referred to as a first hip-x axis, which denotes an abduction/adduction axis. The axis 238 may be referred to as a first hip-z axis, which denotes a pronation/supination axis. FIG. 2B shows a set of reference axes to illustrate the x, y and z directions, although the actual x, y, and z axes in the robot 200 need not be mutually orthogonal or extend from the same origin. In some embodiments, rotation about the first hip-y axis 226 may cause the robot leg 202 to swing upward and backward (e.g., in a direction that would enable the robot 200 to walk forward and backward). In some embodiments, rotation about the first hip-x axis 232 may cause the robot leg 202 to swing inward (e.g., toward a center line between the legs 202, 204 of the robot 200) and outward. In some embodiments, rotation about the first hip-z axis may cause the robot leg 202 to rotate the stance of the leg (e.g., twist it to the left or to the right). In some embodiments, the leg member 234 is an upper leg member, which may in turn be connected to a lower leg member 242 at a knee joint 240. In some embodiments, the lower leg member 242 is connected to a foot (e.g., foot 212) at an ankle joint.

In some embodiments, the pelvis base 220 is rotatably connected and/or configured to be rotatably connected to a back member 244 (also referred to herein as a “torso”) of the robot 290. An electric actuator 246 may be disposed between the pelvis base 220 and the back member 244 (e.g., in, between, connected to, and/or part of one or both components). In some embodiments, a first portion of the electric actuator 246 may be fixed to the pelvis base 220, and a second portion of the electric actuator 246 may be fixed to the back member 244. The electric actuator 246 may be configured to rotate the back member 244 relative to pelvis base 220 about an axis (e.g., back-z axis) 248. In some embodiments, the back member 244 is rotatably connected and/or configured to be rotatably connected to a head 210 of the robot 290. An electric actuator 250 may be disposed between the back member 244 and the head 210 (e.g., in, between, connected to, and/or part of one or both components). In some embodiments, a first portion of the electric actuator 250 may be fixed to the head 210 and a second portion of the electric actuator 250 may be fixed to the back member 244. The electric actuator 250 may be configured to rotate the head 210 relative to the back member 244 about an axis (e.g., neck-z axis) 252.

In some embodiments, a first shoulder member 256 is rotatably connected and/or configured to be rotatably connected to a back member 244 of the robot 290. An electric actuator 254 may be disposed between the back member 244 and the first shoulder member 256 (e.g., in, between, connected to, and/or part of one or both components). In some embodiments, a first portion of the electric actuator 254 may be fixed to the first shoulder member 256, and a second portion of the electric actuator 254 may be fixed to the back member 244. The electric actuator 254 may be configured to rotate the first shoulder member 256 relative to the back member 244 about an axis (e.g., shoulder-y axis) 258. In some embodiments, the first shoulder member 256 is rotatably connected and/or configured to be rotatably connected to a first intermediate arm member 260 of the robot 290. An electric actuator 262 may be disposed between the first shoulder member 256 and the first intermediate arm member 260 (e.g., in, between, connected to, and/or part of one or both components). In some embodiments, a first portion of the electric actuator 262 may be fixed to the first intermediate arm member 260, and a second portion of the electric actuator 262 may be fixed to the first shoulder member 256. The electric actuator 262 may be configured to rotate the first intermediate arm member 260 relative to the first shoulder member 256 about an axis to provide adduction/abduction of the first intermediate arm member 260 relative to the first shoulder member 256. In some embodiments, a first upper arm member 264 is rotatably connected and/or configured to be rotatably connected to the first intermediate arm member 260 of the robot 290. An electric actuator 266 may be disposed between the first arm member 264 and the first intermediate arm member 260 (e.g., in, between, connected to, and/or part of one or both components). In some embodiments, a first portion of the electric actuator 266 may be fixed to the first arm member 264, and a second portion of the electric actuator 266 may be fixed to the first intermediate arm member 260. The electric actuator 266 may be configured to rotate the first arm member 264 relative to the first intermediate arm member 260 about an axis (e.g., shoulder-z axis) 268.

In some embodiments, the first arm member 264 may in turn be connected to a first lower arm member 272 at a first elbow joint. An electric actuator 270 may be disposed between the first arm member 264 and the first lower arm member 272 (e.g., in, between, connected to, and/or part of one or both components). In some embodiments, a first portion of the electric actuator 270 may be fixed to the first arm member 264, and a second portion of the electric actuator 270 may be fixed to the first lower arm member 272. The electric actuator 270 may be configured to rotate the first arm member 264 relative to the first lower arm member 272 about an axis that provides flexion/extension of the first lower arm member 272 relative to the first arm member 264. In some embodiments, rotation about the first elbow joint may be greater than 90 degrees. In some embodiments, rotation about the first elbow joint may be greater than 180 degrees.

In some embodiments, the first lower arm member 272 is connected to an end effector (e.g., a gripper or hand) via a wrist component. The wrist component may contain one or more actuators configured to provide various ranges of motion to the wrist of the robot. In some embodiments, a second shoulder member, second intermediate arm member, second upper arm member, and second lower arm member are connected in similar fashion to the first shoulder member, first intermediate arm member, first upper arm member, and first lower arm member using similar actuators rotating along similar additional axes and/or providing similar independently actuatable degrees of freedom.

As described above, a robot (e.g., a humanoid robot) may include a controller configured to execute a set of control methods (e.g., control policies) that enable the robot to move in prescribed ways to perform a variety of tasks. For instance, the set of control policies may include a first control policy to enable a robot to grasp an object with a first end effector of the robot, a second control policy to enable the robot to grasp the object with a second end effector of the robot, and a third control policy to enable the robot to perform a bimanual manipulation of the object when grasped by the first and second end effectors. In some embodiments, the set of control policies may include a single learned control policy the enables the robot to perform a combined mobility and manipulation task. Some conventional techniques for generating a control policy for a robot include hand authoring (e.g., hard coding) such policies by a skilled programmer. However, such techniques may take a significant amount of programming effort and time and/or may not be generalizable or scalable to enable a robot to learn to perform a wide variety of object manipulation tasks. Some embodiments of the present disclosure relate to techniques for learning (e.g., using one or more machine learning techniques) one or more control methods (e.g., one or more control policies) for a robot based on video data depicting a demonstration (e.g., a human demonstration) of an object manipulation task.

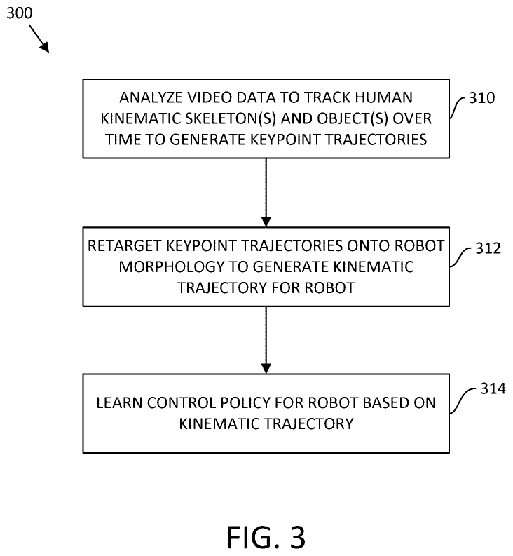

FIG. 3 is a flowchart of a process 300 for learning a control policy for a robot based on video data, in accordance with some embodiments of the present disclosure. Process 300 begins in act 310, where video data is analyzed to track one or more kinematic skeletons(s) (e.g., corresponding to one or more humans in the video data) and one or more objects with which the human(s) in the video are interacting over time. In some embodiments, each frame of the video data may be analyzed to identify a set of keypoints including a first set of points associated with the human(s) and a second set of points associated with the object(s), with each keypoint representing a position of a relevant feature in the frame. By tracking a consistent set of keypoints across frames of the video data, points corresponding to the human and the object that may be relevant for enabling a humanoid robot to perform a similar object interaction may be tracked over time. In some embodiments, a two-dimensional human skeleton tracking model may be used to identify keypoints corresponding to points on the human(s) and an object detection/segmentation and/or pose estimation model may be used to identify keypoints corresponding to the object(s) in each frame of the video data. In some embodiments, keypoints corresponding to object(s) may be predicted directly from the video data using a model. In some embodiments, one or more markers (e.g., fiducial markers, distinctive characteristics) on the object(s) may facilitate identifying the keypoints corresponding to the object(s).

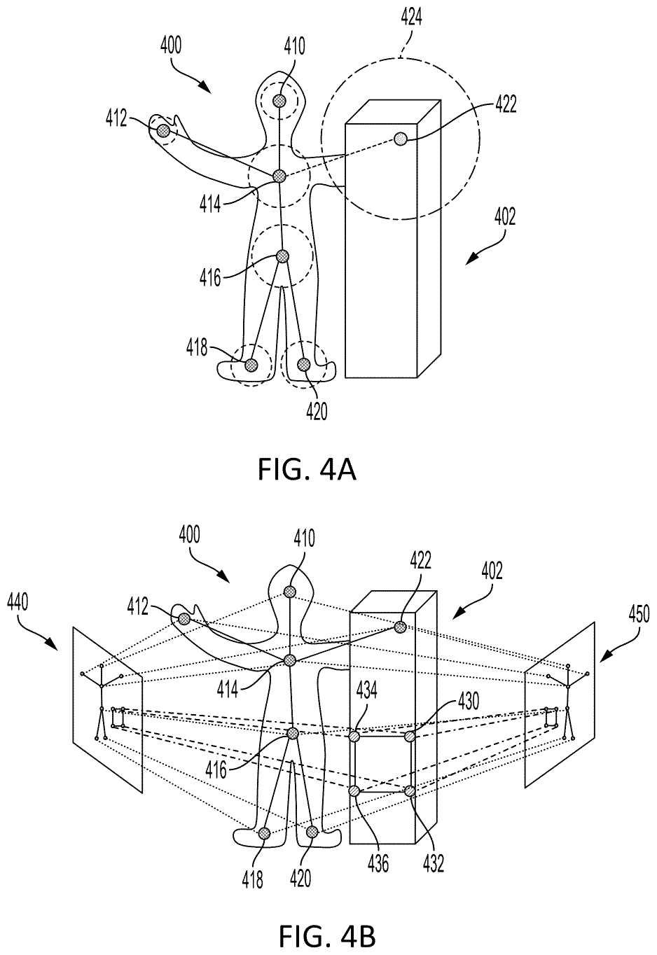

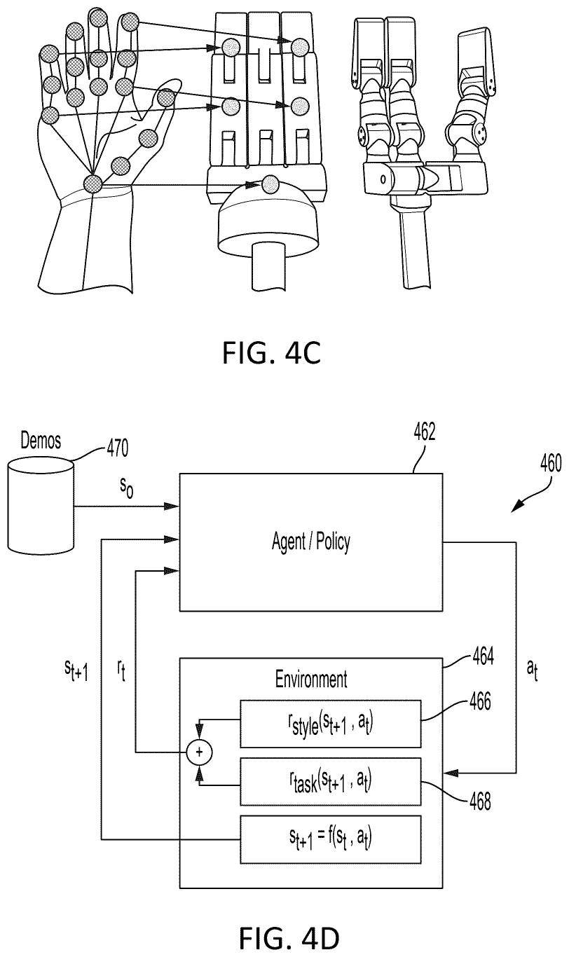

FIG. 4A schematically illustrates a keypoint multi-target tracking (MTT) technique in which a set of keypoints associated with a human 400 are identified in an image (e.g., a frame of video data). As shown in FIG. 4A, the set of keypoints may include a head keypoint 410, a right hand keypoint 412, a chest keypoint 414, a pelvis keypoint 416, a right foot keypoint 418, a left foot keypoint 420 and a left hand keypoint 422. In the example shown in FIG. 4A, left hand keypoint 422 is obstructed by object 402 in the image. In some embodiments, each keypoint in the set of keypoints may be associated with a confidence value representing a confidence that the position of the keypoint has been identified correctly in the image. In the example of FIG. 4A, the confidence value associated with each keypoint is represented by the size of a circle 424 surrounding the keypoint. As shown, the confidence value for the obstructed left hand keypoint 422 is large compared with other keypoints identified in the image, which reflects the uncertainty associated with the obstructed left hand keypoint 422. It should be appreciated that the set of keypoints may include any suitable number of keypoints, and the set of keypoints illustrated in FIG. 4A is provided merely as an example. Additionally, although the set of keypoints shown in FIG. 4A only identifies keypoints associated with human 400, it should be appreciated that one or more keypoints associated with object 402 may also be identified and tracked over time in the frames of video data.

After identifying the set of keypoints for the human(s) and the object(s) in each frame of the video data, a trajectory may be determined for each of the keypoints in the set of keypoints by analyzing how the positions of the keypoints change across the frames of video data. In some embodiments, the video data may include multi-view video data in which the human(s) are shown interacting with the same object(s), but from different viewpoints. Because the position of the cameras capturing the different views are located at different distances from the tracked human(s) and object(s) in the multi-view video data, three-dimensional keypoint trajectories may be determined for each keypoint in the set of keypoints by estimating depth information for the tracked keypoints based on the camera locations.

In some embodiments, the mapping from keypoints to robot/object trajectories may be implemented as a learned function. In some embodiments, the keypoint trajectories may be determined using an optimization process (e.g., an iterative optimization process) that takes as input, the set of keypoints identified in each frame and view of the video data. In some embodiments, keypoints may be projected from first video data corresponding to the first view into second video data corresponding to a second view, and the reprojection loss of the set of keypoints may be minimized in the optimization. The optimization process may take into consideration information about human-object interactions (e.g., fingers can contact objects) and/or information about the physical world (e.g., objects have mass, skeletons do not deform appreciably, humans and objects cannot teleport to different locations across adjacent or close in time frames, motion of keypoints across time should be smooth, length of body parts or dimensions of objects do not change appreciably over time). For instance, one or more priors may be defined to constrain the optimization to solutions that are practical in the real world. In some embodiments, the optimization process may be configured (e.g., using one or more priors or constraints) to ensure consistency and/or perform outlier rejection. For instance, one or more of the keypoints identified in the set of keypoints may result in human and/or object poses that are not feasible, and the optimization process may reject such keypoints when performing the optimization. It should be appreciated that not all keypoints in the set of keypoints may be identified with high confidence in each frame of the video data (e.g., due to occlusions as described above). In some embodiments, confidence values associated with keypoints may be used to weight keypoints differently when combining keypoint information across frames and/or views to determine keypoint trajectories (e.g., using optimization). For instance, keypoints associated with high confidence values may be associated with higher weights when determining keypoint trajectories compared with keypoints associated with lower confidence values. The output of the optimization process may include real-world plausible keypoint trajectories (e.g., three-dimensional keypoint trajectories) for the human skeleton(s) and object(s) in the video data.

FIG. 4B schematically illustrates a process for combining keypoint data across multiple views using data fusion, in accordance with some embodiments. In the example of FIG. 4B, a set of keypoints are identified in a first image 440 and a second image 450. The set of keypoints may include all of the human skeleton keypoints shown in FIG. 4A in addition to one or more keypoints associated with object 402. For instance, object keypoints 430, 432, 434, and 436 may also be identified in each of image 440 and 450 and included in the set of keypoints. When considered across all of the frames of video data, a set of keypoints that correspond to the human 400 and the object 402 may be determined.

The keypoint trajectories generated in act 310 of process 300 shown in FIG. 3, while plausible in the real world, may not take into account differences between the morphology of the human depicted in the video data and the morphology of a robot on which a control policy is to be generated. Accordingly, after keypoint trajectories are generated in act 310, process 300 proceeds to act 312, where the keypoint trajectories are retargeted onto the robot morphology to generate kinematic trajectories for the robot. In some embodiments, the generated kinematic trajectories may include a trajectory of each of the joints of the robot and the one or more objects with which the robot is interacting. The retargeting may be performed in any suitable way. For instance, the keypoint trajectories for the set of keypoints may be provided as input to an inverse kinematics solver that generates kinematic trajectories for the robot across all frames of the video data based on sets of keypoints on the robot and keypoints associated with the human skeleton that are matched (e.g., a head keypoint on the human matched to a head keypoint on the robot).

FIG. 4C schematically illustrates a process for matching human skeleton keypoints to keypoints on a robot morphology, in accordance with some embodiments. As shown in FIG. 4C, when the morphology of the robot is different (e.g., simpler) than that of the human skeleton, a subset of the human skeleton keypoints may be mapped to the robot keypoints to accommodate the different robot morphology. In some instances, a single human skeleton keypoint may be mapped to multiple keypoints on the robot. For instance, a single elbow keypoint on the human skeleton may be mapped to multiple keypoints corresponding to separate robot members coupled at an elbow joint of the robot. In some instances, multiple human skeleton keypoints may be mapped to a single keypoint on the robot.

The inverse kinematics solver may be configured to align the matched keypoints such that they follow each other in a kinematic sense over time. As an example, when the human takes a step in the video, the robot should also take a step as represented in the output kinematic trajectory. In some embodiments, the process used to generate the kinematic trajectory generated in act 312 may reject potential inverse kinematics solutions for which collisions between the robot, the environment, or the objects being manipulated would occur. For instance, the inverse kinematics solver may be configured to include one or more optimization objectives that penalize intersections between the robot, environment and/or objects with which the robot is interacting. In some embodiments, the inverse kinematics solver may use contact geometry constraints (e.g., the robot's head should not be inside of a box it is trying to carry on its shoulder) to generate a kinematic trajectory that is physically realizable. In some embodiments, the inverse kinematics solver may be configured to generate a kinematic trajectory that minimizes postural artifacts.

The retargeted kinematic trajectory output from the inverse kinematics solver may provide a rough trajectory of the robot joints to allow the robot to attempt to perform a desired interaction with an object depicted in the video data. However, the rough kinematic trajectory may be refined by converting the kinematic trajectory into a control policy for a particular robot to enable the robot to successfully complete the desired behaviors. Returning to process 300 shown in FIG. 3, after the robot-specific kinematic trajectory (which may include trajectories for each of the robot's joints and the object being manipulated) is generated in act 312, process 300 may proceed to act 314, where a control policy for the robot is learned based on the kinematic trajectory to enable the robot to perform at least a portion of the task demonstrated in the video data. For instance, the control policy may be learned using machine learning techniques, such as reinforcement learning, to identify control trajectories that enable the robot to execute the kinematic trajectory, while filtering out control trajectories that are not feasible for the robot to perform. In some embodiments, learning a control policy comprises using an adversarial motion priors (AMP) technique to train the control policy. For example, a model of the robot and the object and robot kinematic trajectories determined from the retargeting may be used to train a neural network to replicate a style of movement represented in the video demonstration data.

FIG. 4D schematically illustrates a processing architecture 460 for using adversarial motion priors to generate a control policy for a robot, in accordance with some embodiments of the present disclosure. Using the processing architecture 460, a control policy 462 that maximizes an expected sum of future discounted rewards, rt based on an environment 464 may be determined. The inclusion of adversarial motion priors adds a style reward 466 to regularize the control policy 462. As shown in the processing architecture 460, the style reward 466 is added to a task reward 468, which defines the task to be performed, to generate rt at each timestep t. The style reward 466 may be learned using multiple video demonstrations spanning different tasks. In some embodiments, the style reward 466 may be obtained by training a classifier (e.g., a binary classifier) that differentiates between samples from the control policy 462 or the video data demonstrations 470. In some embodiments, the style reward 466 may correspond to the negative log-likelihood of the classifier, which may be used at inference time within the processing architecture 460 during reinforcement learning of a control policy 462.

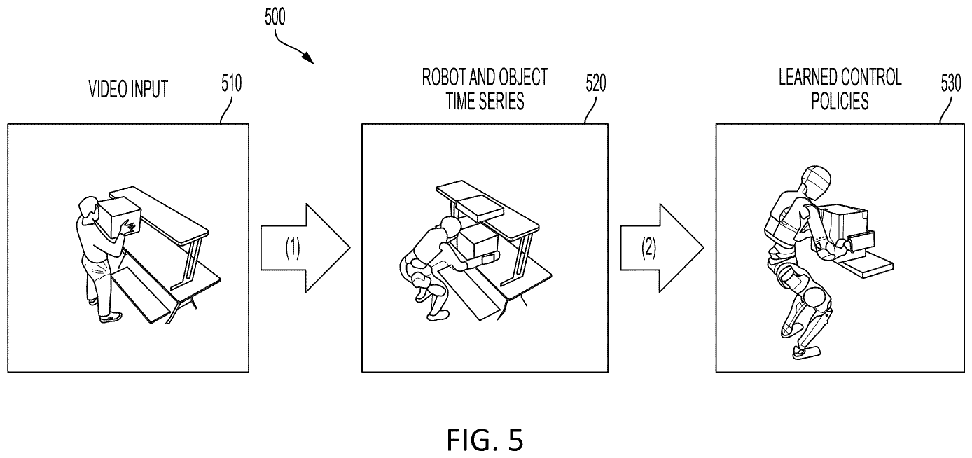

FIG. 5 schematically shows a process 500 for learning a control policy for a robot based on video data in accordance with some embodiments of the present disclosure. For instance, as described in connection with process 300 shown in FIG. 3, video data 510 depicting one or more humans interacting with an object may be used to determine a kinematic trajectory 520 for the robot and the object. In the example shown in FIG. 5, the video data 510 includes a human lifting a box using two hands placed on either side of the box. As described in connection with process 300, the video data 510 may be analyzed to identify one or more features (e.g., a set of keypoints) associated with the human and the object being manipulated. When the video data 510 includes multi-view video data, three-dimensional trajectories for each of the identified feature(s) may be determined. The three-dimensional trajectories of the tracked features from the video data 510 may be mapped onto the robot morphology, such that a kinematic trajectory 520 for the robot and the object may be generated. For example, the three-dimensional trajectory information may be processed to solve an inverse kinematics problem across the frames of the video data 510 to produce the kinematic trajectory 520 for the robot and the object. The kinematic trajectory 520 for the robot and the object may then be provided as input to a control policy learning system to convert the kinematic trajectory 520 into a control policy, which may be executed by a controller of the robot to perform at least a portion of the task illustrated in the video data 510.

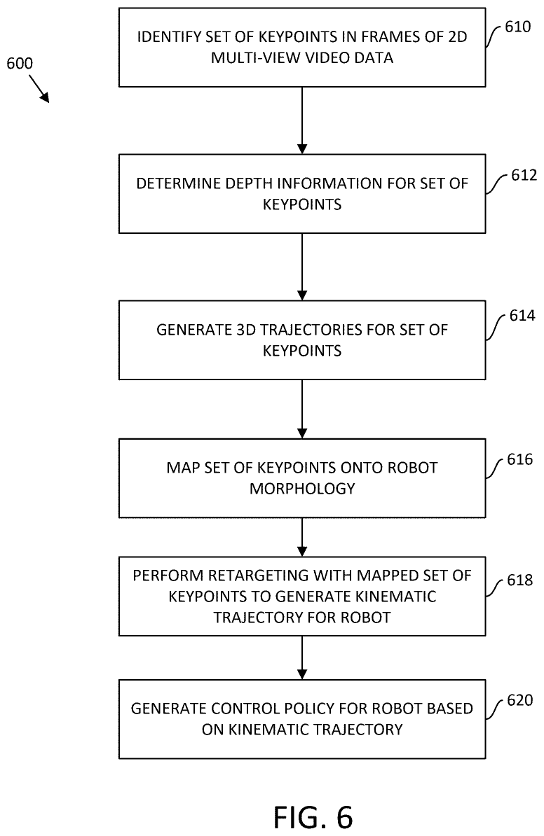

FIG. 6 is a flowchart of process 600 for generating a control policy for a robot in accordance with some embodiments of the present disclosure. Process 600 begins in act 610 where multi-view two-dimensional video data is received and processed to identify a set of keypoints (e.g., for human(s) and/or object(s)) in each frame of the video data for each of the views. Process 600 then proceeds to act 612, where depth information is determined for the keypoints in the set of keypoints. As discussed above, multi-view video data may be captured from cameras having different viewpoints of one or more bipeds (e.g., humans, humanoid robots) interacting with one or more objects. Because the cameras have different positions relative to the keypoints being tracked, depth information associated with the keypoints may be determined. Process 600 then proceeds to act 614, where three-dimensional (3D) trajectories for the keypoints in the set of keypoints are determined using, for example, data fusion according to an iterative optimization process that leverages priors about (e.g., skeleton deformation, inertia/smoothness of motion, etc.) to ensure that the keypoint trajectories are feasible according to real world conditions imposed during the optimization. Process 600 may then proceed to act 616, where the set of keypoints is mapped onto the morphology of a robot. As described in connection with FIG. 4B, one or more human skeleton keypoints may be mapped onto one or more robot keypoints in a one-to-one, one-to-many, or many-to-one manner, as described herein. Process 600 may then proceed to act 618, where the mapped set of keypoints is used to generate a kinematic trajectory for the robot. As described herein, an inverse kinematics problem may be solved using an optimization to generate the kinematic trajectory, which may include trajectories for each of the joints of the robot and the object to be manipulated by the robot. Process 600 may then proceed to act 620, where a control policy is generated for the robot based on the kinematic trajectory. For instance, as described herein, machine learning techniques using adversarial motion priors and the kinematic trajectory may be used to learn the control policy. In some embodiments, a control policy generated in act 620 may be learned directly from the 3D trajectories for each of the keypoints in the set of keypoints determined in act 614 without having to generate a kinematic trajectory for the robot in act 618, such that at least act 618 may be omitted from the control policy learning process 600.

A number of implementations have been described. Nevertheless, it will be understood that various modifications may be made without departing from the spirit and scope of the disclosure.

1. A method for controlling a robot, the method comprising:
receiving a kinematic trajectory for a robot, wherein the kinematic trajectory is based, at least in part, on one or more features extracted from video data, the video data including one or more bipeds performing a task by interacting with one or more objects, the one or more features including a first feature corresponding to a biped and second feature corresponding to an object; and
determining a control policy for the robot based, at least in part, on the kinematic trajectory.

2. The method of claim 1, further comprising:
receiving the video data; and
extracting, with at least one processor, the one or more features from the video data,
wherein receiving the kinematic trajectory for the robot comprises determining the kinematic trajectory based, at least in part, on the one or more features.

3. The method of claim 2, wherein
the video data includes first video data showing a first view of the one or more bipeds performing the task and second video data showing a second view of the one or more bipeds performing the task,
extracting the one or more features comprises extracting the one or more features from the first video data and the second video data, and
determining the kinematic trajectory is based, at least in part, on the one or more features extracted from the first video data and the one or more features extracted from the second video data.

4. The method of claim 3, wherein
the one or more features include a set of keypoints located on the one or more bipeds and the one or more objects,
extracting the one or more features comprises identifying the set of keypoints in the first video data and the second video data, and
determining the kinematic trajectory comprises combining information from the set of keypoints identified in the first video data and information from the set of keypoints identified in the second video data to determine the kinematic trajectory as a three-dimensional kinematic trajectory.

5. The method of claim 4, wherein combining information from the set of keypoints identified in the first video data and information from the set of keypoints identified in the second video data comprises:
determining depth information for one or more keypoints in the set of keypoints; and
determining the kinematic trajectory based, at least in part, on the depth information.

6. The method of claim 4, wherein the set of keypoints is a first set of keypoints, and the method further comprises:
defining a mapping between the first set of keypoints and a second set of keypoints defined on a morphology of the robot,
wherein determining the kinematic trajectory is further based, at least in part, on the mapping.

7. The method of claim 6, wherein determining the kinematic trajectory based, at least in part, on the mapping comprises performing retargeting of the set of keypoints onto the morphology of the robot using the mapping.

8. The method of claim 4, further comprising:
determining, for each keypoint in the set of keypoints, a keypoint trajectory based on the first video data and the second video data,
wherein determining the kinematic trajectory is further based on the keypoint trajectories.

9. The method of claim 1, wherein the kinematic trajectory is further based, at least in part, on information about the robot.

10. (canceled)

11. The method of claim 1, wherein determining a control policy for the robot based, at least in part, on the kinematic trajectory comprises using adversarial motion priors to determine the control policy.

12. The method of claim 1, wherein determining a control policy for the robot comprises determining the control policy based, at least in part, on contact geometry between the robot and the object.

13. The method of claim 1, wherein the control policy comprises a control policy for controlling the robot to manipulate an object.

14. The method of claim 1, further comprising:
controlling the robot to execute the control policy to perform the task.

15. The method of claim 1, wherein the one or more bipeds include one or more humans.

16. A controller for a robot, the controller configured to:
receive a kinematic trajectory for the robot, wherein the kinematic trajectory is based, at least in part, on one or more features extracted from video data, the video data including one or more bipeds performing a task by interacting with one or more objects, the one or more features including a first feature corresponding to a human and second feature corresponding to an object;
determine a control policy for the robot based, at least in part, on the kinematic trajectory; and
control the robot to execute the control policy to perform the task.

17. The controller of claim 16, wherein the controller is further configured to:
receive the video data;
extract the one or more features from the video data; and
determine the kinematic trajectory based, at least in part, on the one or more features.

18. The controller of claim 17, wherein
the video data includes first video data showing a first view of the one or more bipeds performing the task and second video data showing a second view of the one or more bipeds performing the task,
the controller is configured to extract the one or more features by extracting the one or more features from the first video data and the second video data, and
the controller is configured to determine the kinematic trajectory based, at least in part, on the one or more features extracted from the first video data and the one or more features extracted from the second video data.

19. The controller of claim 18, wherein
the one or more features include a set of keypoints located on the one or more bipeds and the one or more objects,
the controller is configured to extract the one or more features by identifying the set of keypoints in the first video data and the second video data, and
the controller is configured to determine the kinematic trajectory by combining information from the set of keypoints identified in the first video data and information from the set of keypoints identified in the second video data to determine the kinematic trajectory as a three-dimensional kinematic trajectory.

20-29. (canceled)

30. A robot comprising:
a set of members;
a set of joints coupling the set of members;
a set of actuators configured to move the set of members at the set of joints; and
a controller configured to:
execute a control policy to control the set of actuators to enable the robot to perform a task,
wherein the control policy is based, at least in part, on a kinematic trajectory for the robot, and
wherein the kinematic trajectory for the robot is based, at least in part, on one or more features extracted from video data, the video data including one or more bipeds performing the task by interacting with one or more objects, the one or more features including a first feature corresponding to a biped and second feature corresponding to an object.

31. (canceled)
